(19) United States
(12) Patent Application Publication
(10) Pub. No.: US 2009/0233121 A1
(43) Pub. Date: Sep. 17, 2009

(54) LAMINATED GLAZING COMPRISING A STACK OF THIN LAYERS REFLECTING THE INFRARED RAYS AND/OR THE SOLAR RADIATION, AND A HEATING MEANS

(75) Inventor: Jean-Gerard Leconte, Courbevoie (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 11/574,421

(22) PCT Filed: Aug. 31, 2005
(86) PCT No.: PCT/FR2005/050693

§ 371 Date: Nov. 15, 2007

(30) Foreign Application Priority Data
Aug. 31, 2004 (FR) 0451947

(51) Int. Cl. B32B 15/04

(52) U.S. Cl. 428/626

(57) ABSTRACT

The invention relates to a laminated glazing (10, 10′) for vehicles, comprising at least one interlayer sheet (13, 16) of thermoplastic polymer positioned between two substrates (11, 17), each substrate thus having a respective face (2, 3) turned toward said interlayer sheet (13, 16), said glazing having reflection properties in the infrared and/or in solar radiation, characterized in that a heating means (12) having a power density of at least 400 W/m², or even at least 500 W/m², is associated with the face (2), in that a means (15) having reflection properties in the infrared and/or in solar radiation is associated with the face (3) and in that said glazing has a light transmission of at least 70%, or even at least 75%.

The invention relates to glazing incorporating, on the one hand, at least one transparent substrate, made of glass or of organic material, which is provided with means that can act on long-wavelength infrared radiation and/or solar radiation and, on the other hand, with a heating means.

The invention relates more particularly to laminated glazing, especially for the windshield or front side windows of a vehicle, and more particularly a motor vehicle, this laminated glazing comprising at least one interlayer sheet of thermoplastic polymer positioned between two glass substrates, each glass substrate thus having a respective face turned toward said interlayer sheet, said glazing having reflection properties in the infrared and/or in solar radiation.

The invention also relates to heated glazing. Heated glazing is glazing whose temperature can be raised when an electrical current is applied thereto. This type of glazing finds applications in automobiles for the production of panes that prevent icing or fogging from forming thereon, or even that eliminate any icing or fogging.

The invention relates more particularly, but not solely, to means having reflection properties in the infrared and/or in solar radiation consisting of a multilayer comprising an alternation of at least one metal, especially silver-based, functional layer and of layers made of a dielectric of the metal oxide or silicon nitride type.

The invention relates even more particularly to glazing that incorporates at least one substrate provided with such a multilayer, this substrate having to undergo conversion operations involving at least one heat treatment at least 500° C. This treatment may especially be a toughening, annealing or bending treatment.

Rather than depositing the thin films constituting the multilayer consisting of one or more functional metal layers on the substrate after its heat treatment (which raises considerable technological problems), it was firstly sought to adapt the multilayers so that they can undergo such treatments while still maintaining most of their thermal properties. The objective was therefore to prevent the functional layers, especially the silver-based layers, from deteriorating. One solution, disclosed in patent EP 506 507, consists in protecting the silver layers by flanking them with metal layers that protect the silver layers. This therefore gives a bendable or toughenable multilayer insofar as it is at least as efficient in reflecting infrared or solar radiation after the bending or toughening operation as it was beforehand. However, the oxidation/modification of the layers that protected the silver layers from the effect of the heat result in the optical properties of the multilayer being substantially modified, especially resulting in an increase in the light transmission and a modification in the colorimetric response in reflection. This heat treatment also tends to create optical defects—pinholes and/or various small impairments resulting in a significant level of haze (the expression “small impairments” is generally understood to mean defects having a size of less than 5 microns, whereas “pinholes” refers to defects having a size of greater than 50 microns, especially between 50 and 100 microns, but with, of course, the possibility of also having defects of intermediate size, that is to say between 5 and 50 microns).

Secondly, it was then endeavored to develop such thin-film multilayers capable of retaining both their thermal properties and their optical properties after heat treatment, while minimizing any appearance of optical defects. The challenge was thus to obtain thin-film multilayers of constant optical/thermal performance whether or not they have to undergo heat treatments.

A first solution was proposed in patent EP-718 250. This recommends using, above the silver-based functional layer or layers, oxygen diffusion barrier layers, especially those based on silicon nitride, and depositing the silver layers directly on the subjacent dielectric coating, without interposition of priming layers or metal protection layers. This patent discloses multilayers of the type:
Si₃N₄/ZnO/Ag/Nb/ZnO/Si₃N₄
   or
SnO₂/ZnO/Ag/Nb/Si₃N₄.

A second solution was proposed in patent EP-847 965. This is based more on multilayers comprising two silver layers and describes the use both of a barrier layer above the silver layers (as previously) and of an absorbent or stabilizing layer adjacent said silver layers and allowing them to be stabilized.

This patent discloses multilayers of the type:
SnO₂/ZnO/Ag/Nb/Si₃N₄/ZnO/Ag/Nb/WO₃ or ZnO or SnO₂/Si₃N₄.

In both solutions, it should be noted that there is a metal layer, in this case made of niobium, on the silver layers, preventing the silver layers from coming into contact with an oxidizing or nitriding reactive atmosphere during deposition by reactive sputtering of the ZnO layer or of the Si₃N₄ layer, respectively.

These solutions are satisfactory in most cases. However, there is an increasing need to have glass panes of very pronounced curvature and/or of complex shape (double curvature, S-shaped curvature, etc.). This is most particularly the case of glass panes used for automobile windshields or for shop windows. In this case, the glass panes have to undergo locally differentiated treatments from the thermal and/or mechanical standpoint, as disclosed in particular in the patents FR-2 599 357, U.S. Pat. No. 6,158,247, U.S. Pat. No. 4,915,722 or U.S. Pat. No. 4,764,196. This is particularly stressing for the thin-film multilayers—localized optical defects, slight variations in appearance in reflection from one point in the glazing to another, may then arise.

One solution has improved the thin-film multilayers described above, especially by improving their behavior when subjected to stressing heat treatments of the bending and/or toughening type. International application WO 03/010105 thus discloses a solution for preserving the thermal performance of the multilayers while minimizing any optical modification thereof, and any appearance of optical defects, particularly while maintaining the uniformity of optical appearance of the glass panes coated after heat treatment, from one pane to another and/or from one region to another of the same pane, and to do so even in the case of a treatment that differs locally from one point on the glazing to another. This solution therefore minimizes any optical variation from one point on the glazing to another, especially in the case of a pane that has to be bent, from a slightly bent or unbent region to a highly bent region.

This solution goes counter to what was usually done, since it proposes to omit the “sacrificial” metal layer above the functional layers, especially the silver layers, and since this metal layer is displaced, by placing it beneath said functional layers.

Particular problems arise when it is desired to combine, on the inside of the same glazing, a means having reflection properties in the infrared and/or in solar radiation, consisting in particular of a thin-film multilayer and a heating means.

This combination firstly poses an industrial production problem: since each of the means, on the one hand the means having reflection properties in the infrared and/or in solar radiation and on the other hand the heating means, is in general associated with a substrate, the question of ascertaining whether these two means can be associated with the same substrate or whether they have to be associated with different substrates, and in this case which substrates (outer substrates, interlayer sheet, central sheet, . . . , inner substrate) arises.

Furthermore, this association poses the problem of how to obtain or preserve the optical (color, light transmission T_{L}, etc.) and energy (energy reflection R_{E}) properties.

The object of the present invention is to propose a solution to the problems posed by the prior art, and thus relates, in its widest aspect, to laminated glazing of the type described above, in which a heating means having a power density of at least 400 W/m², or even at least 500 W/m², is associated with the face (2) of the laminated glazing, in that a means having reflection properties in the infrared and/or in solar radiation is associated with the face (3) of the laminated glazing and in that said glazing has a light transmission T_{L} of at least 70%, or even at least 75%, this T_{L} being measured in a customary manner perpendicular to the mean plane of the glazing.

Throughout the present document, those faces of the two glass substrates incorporated into the laminated glazing are numbered, as is conventional, 1, 2, 3 and 4 going from the outside of the glazing, that is to say from the side placed on the outside when this glazing is fitted into a body opening, toward the inside.

Preferably, said heating means is positioned against that face of the interlayer sheet which is turned toward the outside.

The present invention proposes two main embodiments. In a first embodiment, said means having reflection properties in the infrared and/or in solar radiation is positioned on that face of the inner substrate which is turned toward the outside of the vehicle, and in a second embodiment it is positioned, on that face of a central thermoplastic polymer sheet which is turned toward the inside of the vehicle, said central thermoplastic polymer sheet being positioned between two interlayer thermoplastic polymer sheets.

The invention may apply to means having reflection properties in the infrared and/or in solar radiation consisting for example of films having reflection properties in the infrared and/or in solar radiation.

However, the means having reflection properties in the infrared and/or in solar radiation preferably consists of a thin-film multilayer comprising an alternation of n functional layers A having reflection properties in the infrared and/or in solar radiation, especially metal layers, and n+1 coatings B where n≧1. Said coatings B comprise a dielectric layer or a superposition of dielectric layers so that each functional layer A is placed between two coatings B.

The multilayer preferably also has the following features:

The functional layer A (or at least one of the functional layers A) is in contact with the dielectric coating B placed above and/or below it via a layer C that absorbs at least in the visible, of the metallic, and optionally nitrided, type. However, in one particular version, only the dielectric coating B placed beneath the functional layer A (or at least one of the functional layers A) is in contact with it via a layer C that absorbs at least in the visible, of the metallic, optionally nitrided, type.

Preferably, each of the functional layers A is directly in contact with the dielectric coating B placed above it, and each of the functional layers A is in contact with the dielectric coating B placed beneath them via a layer C that absorbs at least in the visible, of the metallic, optionally nitrided, type.

The invention thus applies to thin-film multilayers that incorporate at least one metal functional layer and preferably several metal functional layers, this layer or these layers being especially based on silver.

The rest of the document will, for the sake of clarity, refer without distinction to silver layers, Ag layers, silver-based layers and functional layers A, acknowledging the fact that silver-based layers are the most common for the applications envisaged in the invention, but that the invention applies in the same way to other reflecting metal layers, such as those made of silver alloys containing in particular titanium and/or palladium, or gold-based layers.

In the case of thin-film multilayers that include a silver-based functional layer A, advantageously the thickness of the (or each) absorbent layer C does not exceed 1 nm, especially does not exceed 0.7 or 0.6 or 0.5 nm. For example, the thickness is about 0.2 to 0.5 nm. The term “layer” is therefore to be taken broadly. This is because layers, if thin, need not be continuous—they may instead form islands on the subjacent layer.

This extreme thinness has several advantages: the layer may fulfill its role as a “trap” for species that would attack the material of the functional layer A, in this case made of silver, during the heat treatments. However, it has only a very slight adverse effect on the multilayer in terms of loss of light transmission, and is rapidly deposited by cathode sputtering. Perhaps more importantly, where appropriate, its thinness means that it “does not interfere” (or only very little) with the interaction between the Ag layer and the layer lying beneath this absorbent layer.

If this subjacent layer has a “wetting” effect with respect to the silver layer (for example when there are layers based on zinc oxide, as will be explained later), this advantageous effect may be maintained despite the presence of the absorbent intermediate layer.

In one configuration having several absorbent layers C, it is preferred for the layer C furthest from the substrate to be thicker than the others. There may be a gradient in the thicknesses of the layers C—the further the layer is from its carrier substrate, the thicker it is. This may be explained by the fact that the final absorbent layer C can thus help to protect the functional layers A that have been deposited before the absorbent layers. In a multilayer with two layers C and two layers A, the ratio of the thickness of the second absorbent layer to the first absorbent layer may thus be from about 2/3 to 1/3 (for example from 75-25 to 55-45 as a thickness percentage).

The absorbent layer or layers C according to the invention are preferably based on titanium (Ti), nickel (Ni), chromium (Cr), niobium (Nb) or zirconium (Zr) or on a metal alloy containing at least one of these metals. Titanium has proved to be particularly appropriate.

Advantageously, at least one (and in particular each) of the coatings B that lies directly above a functional layer A starts with a layer D based on one or more metal oxides. This amounts to saying that there is a direct contact between the or each of the functional layers and the metal oxide layer(s) surmounting it (or at least in respect of one of the functional layers).

This oxide layer may fulfill the stabilization function mentioned in the above patent EP-847 965. It may help to stabilize the silver, in particular in the event of heat treatment. It also tends to promote the adhesion of the entire multilayer. Preferably, this is a layer based on zinc oxide or a mixed oxide of zinc and another metal (of the Al type). It may also comprise oxides containing at least one of the following metals: Al, Ti, Sn, Zr, Nb, W, Ta. An example of a mixed zinc oxide that can be deposited as a thin film according to the invention is a zinc-tin mixed oxide containing an additional element such as antimony, as described in WO 00/24686.

Preferably, this layer D is of limited thickness—for example it is from 2 to 30 nm, especially 5 to 10 nm.

Also advantageously, at least one (in particular each) of the coatings B that lies just beneath a functional layer A terminates in a layer D′ based on one or more metal oxides. This may be the same zinc oxide or mixed oxide containing zinc as for the layers D described above. However, it is unnecessary here for the oxygen stoichiometry thereof to be controlled as precisely—the layers may be stoichiometric layers. ZnO-containing layers are particularly advantageous as they have the property of wetting silver well, facilitating its crystalline growth insofar as ZnO and silver crystallize in a similar manner with similar lattice parameters—silver can grow in a columnar fashion on a well crystallized layer. The crystallization of zinc oxide is then transferred to the silver via a phenomenon known as heteroepitaxy. This transfer of crystallization and this wettability between the ZnO-containing layer and the Ag layer are maintained despite the interposition of an absorbent layer C provided that the latter is thin enough (at most 1 nm). Preferably, the layer D′ has a thickness of between 6 and 15 nm.

To summarize, the layers C stabilize the Ag layers during heat treatments, without reducing their crystallizability and without inducing excessively high light absorption, if their location and their thickness are selected appropriately. The layers D′ may promote wetting/crystallization of the Ag layers (which at the same time limits post-deposition crystallization of the silver under the effect of a heat treatment, which may result in a change in its properties), and the layers D may serve to stabilize the silver and prevent it in particular from migrating in the form of islands.

To prevent the Ag layers from deteriorating, when hot, by the diffusion of oxygen coming from the ambient atmosphere, it is preferable to provide, at least in the (n+1) th coating B (that is to say the last one starting from the substrate), a layer capable of acting as an oxygen barrier. Preferably, this is a layer based on aluminum nitride and/or silicon nitride. Advantageously, all the coatings B include such a barrier layer. In this way, each of the functional layers A is flanked by two oxygen barrier layers, but these may also possibly be barriers to the diffusion of species migrating from the glass, particularly alkali metals. Preferably, these barrier layers have a thickness of at least 5 nm, especially at least 10 nm, for example between 15 and 50 nm or between 20 and 40 or between 22 and 30 nm when they do not lie between two functional layers. They preferably have a substantially greater thickness when they lie between two functional layers, being in particular of a thickness of at least 10 nm, especially at least 40 nm, for example between 40 and 50 or 70 nm.

In the case of a multilayer comprising at least two functional layers A (n≧2), the thickness of each functional layer may be substantially the same, and may be less than 15 nm. The term “substantially the same” is understood to mean a difference of less than 3 nm between the thicknesses of two adjacent functional layers.

In the case of a multilayer comprising at least two functional layers A (n≧2), it is preferable for a coating B lying between two layers A (especially the nth) to be relatively thick, for example having a thickness of around 50 to 90 nm, in particular 70 to 90 nm.

This coating B may include a diffusion barrier layer as described above with a thickness of 0 to 70 nm, or 0 to 65 nm, especially from 2 to 35 nm, in particular from 5 to 30 nm, possibly associated with an oxide layer D and/or D′ of suitable thickness (thicknesses), especially a layer D and/or a layer D′ with a total thickness of 15 to 90 nm, in particular 35 to 90 nm, especially 35 to 88 nm and more particularly 40 to 85 nm.

One nonlimiting embodiment of the invention consists in providing a multilayer comprising the following sequence one or more times:
. . . /ZnO/Ti/Ag/ZnO/ . . .
   the ZnO possibly containing another metal in minor proportion relative to Zn, of the Al type, and the ZnO above the Ag layer preferably being slightly oxygen-substoichiometric (at the very least before post-deposition heat treatment).

This sequence may occur twice in a multilayer of the type:
substrate/Si₃N₄⁽¹⁾/ZnO/Ti/Ag/ZnO/Si₃N₄⁽²⁾/ZnO/Ti/Ag/ZnO/Si₃N₄⁽³⁾,
   the Si₃N₄ possibly containing another metal or element in a minor amount relative to Si, such as a metal (Al) or boron, and/or the ZnO possibly containing a metal also in a minor amount relative to Zn, of the Al type or boron.

As a variant, the Si₃N₄ layers (1) and/or (2) may be omitted. They may be replaced, for example, with a layer of oxide (SnO₂, zinc-tin mixed oxide, etc.) or the ZnO layer adjacent thereto may be thickened accordingly.

Preferably, in this type of multilayer consisting of two silver layers, the Si₃N₄-based layer between the two silver layers is for example at least 50 nm, especially between 55 and 70 nm, in thickness. On the opposite side from each of the silver layers, it is preferable to provide Si₃N₄-based layers at least 15 nm, especially between 20 and 30 nm, in thickness.

With such a multilayer configuration, the substrates coated according to the invention may undergo treatments above 500° C. for the purpose of carrying out a bending, toughening or annealing operation for example (even bending treatments that differentiate from one point on the substrate to another), with a change in light transmission ΔT_{L} (measured under illuminant D₆₅), between the value before the bending and the value after bending, of at most 5%, especially at most 4%, and/or a change in colorimetric response in reflection ΔE*, between the value before bending and the value after bending, of at most 4, especially at most 3. ΔE is expressed in the following manner in the (L,a*,b*) colorimetry system: ΔE=(ΔL*²+Δa*²+Δb*²)^{1/2}. These ΔE and ΔT_{L} values have in particular been confirmed for glazing with a laminated structure of the type: glass/thermoplastic sheet (such as PVB)/multilayer stack/glass.

Furthermore, excellent uniformity of appearance is observed over the entire surface of the coated substrate.

The coated substrate (made of glass) can then be fitted as laminated glazing, by combining it in a known manner with another glass pane via at least one sheet of thermoplastic polymer. The multilayer is placed so as to be in contact with said thermoplastic sheet, on the inside of the glazing, in accordance with the first main embodiment of the invention.

The glazing may also be mounted as what is called “asymmetric” laminated glazing, by combining it with at least one sheet of polymer of the polyurethane type having energy absorption properties optionally together with another layer of polymer having self-healing properties (the reader may refer to the patents EP-132 198, EP-131 523 and EP-389 3 54 for further details about this type of laminate). The laminated glazing obtained may be used as windshields or side windows of vehicles.

The laminated glazing thus formed exhibits a small variation in colorimetric response between normal incidence and non-normal incidence, typically at 60°. This variation in colorimetric response at non-normal incidence is expressed through the parameters a*(0°) and b*(0°) measured at an angle of incidence of 0° (normal incidence) and a*(60°) and b*(60°) measured at an angle of incidence of 60°. Δa*_{(0→60)} denotes |a*(60°)−a*(0°)| and Δb*_{(0→60)} denotes |b*(60°)−b*(0°)|. The following colorimetric variations are observed: Δa*_{(0→60)}<4 and Δb*_{(0→60)}>2, for a*(60°)<0 and b*(60°)<0.

Thus, for glazing in which a*(0°) is between −6 and −3.5 and b*(0°) is between −3 and 0, viewing at an angle of incidence of 600 gives a small variation in color, with a*(60°) between −4 and 0 and b*(60°) between −4 and 0.

The glazing according to the invention may be provided with a heating means formed by an array of conducting wires, especially twisted wires, or by at least one layer of conductive material or by any other means.

A person skilled in the art knows in this regard that European patent EP-496 669 teaches him a method of depositing conducting wires, especially on an interlayer sheet of laminated glazing. He also knows from European patent EP 773 705 an improvement of this method and from international patent application WO 02/098176 one particular application of these methods to the side windows of motor vehicles.

The heating power of the heating means must be at least 400 or 450 W/m², or even at least 500 W/m², and is preferably around 600 W/m². This means is preferably supplied directly from the battery of the vehicle, which in general delivers a DC current at 12 V.

Preferably, the glazing according to the invention has an energy reflection R_{E} of between 20 and 40% and especially between 25 and 38%, measured in the usual manner perpendicular to the mean plane of the glazing.

Advantageously, when the thin-film multilayer has been deposited on the inner substrate, this substrate undergoes a heat treatment at above 500° C. for the purpose of bending it, with, after bending, a color in external reflection in the blues, in the greens or in the blue-greens.

As mentioned above, one particularly intended application of the invention relates to vehicle glazing, especially for windshields and front side windows. Thanks to the invention, the windshields and front side windows may have outstanding solar-protection and heating functions/properties.

A heating means, whether formed by an array of conducting wires or by at least one layer of conductive material, results in a reduction of about 1.5% in light transmission relative to identical glazing having no such means.

Faced with the above mentioned problem of designing laminated glazing for a vehicle that incorporates a heating means and a means having reflection properties in the infrared and/or in solar radiation, a person skilled in the art may seek to devise a specific means having reflection properties in the infrared and/or in solar radiation that meets the desired criteria.

However, it turns out to be more judicious to seek to adapt an existing means having reflection properties in the infrared and/or in solar radiation so that it meets the desired criteria.

Thus, the present invention also relates to a method of producing laminated glazing for vehicles, comprising at least one interlayer sheet of thermoplastic polymer positioned between two substrates, each substrate thus having a respective face turned toward said interlayer sheet, said glazing having reflection properties in the infrared and/or in solar radiation, characterized in that a heating means having a power of at least 400 W/m², or even at least 500 W/m², is associated with the face (2), and a means having reflection properties in the infrared and/or in solar radiation being associated with the face (3), said means having reflection properties in the infrared and/or in solar radiation is adapted so that said glazing has a light transmission of at least 70%, or even at least 75%.

In particular, when in industrial production the means having reflection properties in the infrared and/or in solar radiation is formed by a thin-film multilayer comprising two metal, especially silver-based, functional layers and is associated with the face (2) of the glazing, it is then essential to associate said heating means with the face (3) of the glazing.

In the method according to the invention, it appears to be possible to achieve the desired objective, when the means having reflection properties in the infrared and/or in solar radiation consists of a thin-film multilayer comprising two metal, especially silver-based, functional layers, by increasing the thickness of the first metal functional layer starting from the substrate and by decreasing the thickness of the second metal functional layer, preferably without modifying the thicknesses of the other layers. However, the increase in the thickness of the first metal functional layer is preferably less, in absolute value, than the decrease in the thickness of the second metal functional layer.

In the method according to the invention, it also appears possible to achieve the desired objective, with either of the above solutions or with both of them, when the means having reflection properties in the infrared and/or in solar radiation consists of a thin-film multilayer comprising two metal, especially silver-based, functional layers, by decreasing the thickness of at least one absorbent layer C placed just beneath a metal functional layer and preferably by decreasing the thickness of all the absorbent layers C placed just beneath each metal functional layer.

The invention will now be described, in greater detail with the aid of the following nonlimiting examples, with reference to the appended figures:

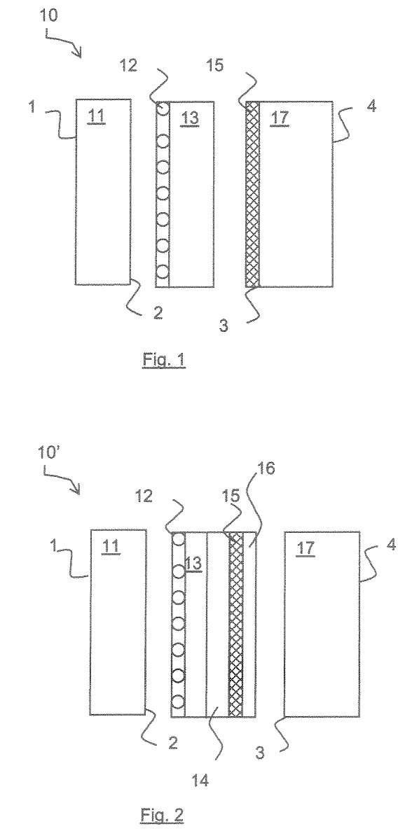

FIG. 1 illustrates an exploded view in cross section of a first embodiment of the invention;

FIG. 2 illustrates an exploded view in cross section of a second embodiment of the invention;

FIG. 3 illustrates the variations in the values a* and b* when the thicknesses of the three silicon-nit ride-based layers Si1, Si2 and Si3 and the two silver layers Ag1 and Ag2, respectively, of a base example are modified;

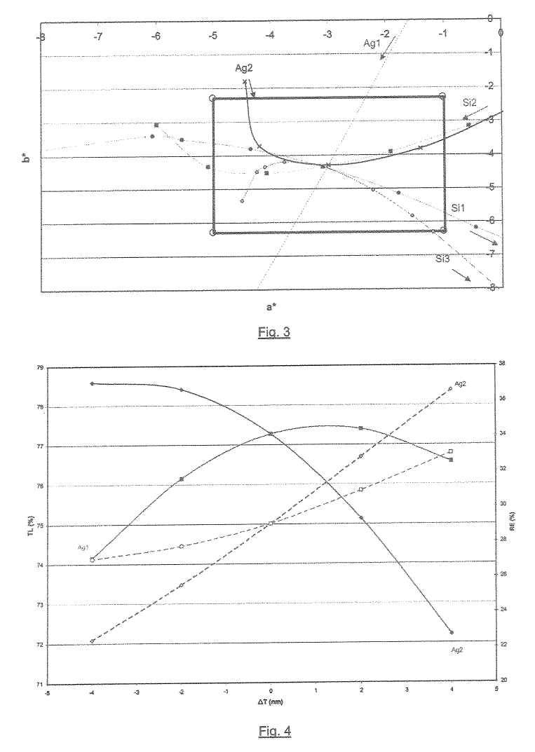

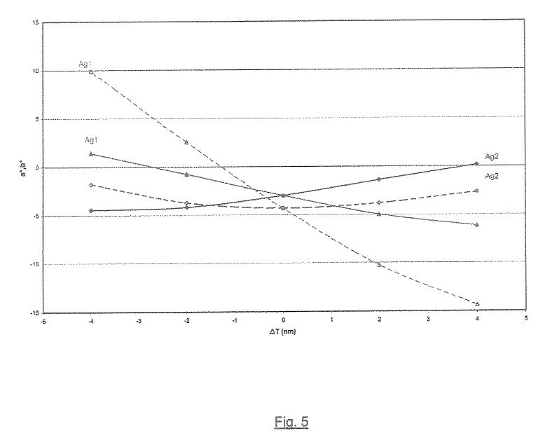

FIG. 4 illustrates the variations in the values of T_{L} and R_{E} when the thicknesses of the two silver layers Ag1 and Ag2, respectively, of a base example are modified;

FIG. 5 illustrates the variations in the values a* and b* values when the thicknesses of the two silver layers Ag1 and Ag2, respectively, of the base example are modified.

It should be pointed that the various elements shown in FIGS. 1 and 2 have not been drawn strictly to scale in these figures so as to make it easier to examine them.

FIGS. 1 and 2 illustrate, respectively, laminated glazing (10, 10′) consisting of two individual substrates, the outer substrate (11) and the inner substrate (17) each having a thickness of 2.1 mm, these being joined together, in a known manner, by adhesive bonding with interposition of a thermoplastic interlayer sheet (13) made of polyvinyl butyral with a thickness of 0.76 mm for example. This glazing is provided with cylindrical heating wires (12) made of lacquered copper, which are placed on the inside of the laminated glazing (10), the wire diameter being about 85 (am.

These heating wires (12) are placed so as to be parallel to one another and extend between the upper and lower edges of the glazing. Using a known method, the heating wires (12) have been laid before the manufacture of the composite glazing on the thermoplastic adhesive sheet (13). The mutual spacing between the individual heating wires (12) is for example from 2 mm to 15 mm.

The heating wires (12) are connected in parallel to two busbars (not illustrated) that are placed a short distance from the respective lower and upper edges of the laminated glazing. To connect the busbars to the onboard power supply, their ends are taken out at the sides of the laminated glazing. An electrical voltage of 12 V is therefore usually applied between the busbars. The current supplied is matched to the heating power needed per unit area, for which it is necessary to take account of the electrical resistance of the heating wires and the distance between them.

The laminated glazing (10) shown in FIG. 1 is manufactured as follows: the two individual substrates (11) and (17) are cut in the usual manner and bent to the desired shape. Independently of this, the thermoplastic adhesive sheet (13) with the busbars and the heating wires (12) is prepared. For this purpose, the heating wires (12) are laid on the polyvinyl butyral sheet, these being fastened to the surface of the sheet using heat and pressure. The heating wires (12) are laid for example using a device that is described in document DE 19 541 427 A1. After the end portions of the heating wires, that possibly extend beyond the heating field bounded between the busbars, have been cut, the thermoplastic adhesive sheet is prepared for the subsequent treatment.

The adhesive sheet thus prepared is joined to the two individual substrates (11) and (17) one of which—the inner substrate (17)—bears a thin-film multilayer (16), and the air is removed from the laminated unit in a known manner by a vacuum treatment. The laminated unit is then finally assembled in an autoclave at a temperature of about 140° C. and at a pressure of about 12 bar.

The manufacture of the laminated glazing (10′) shown in FIG. 2 takes place in the same manner as previously, except that a thin-film multilayer (16) is not on the inner substrate (17) but on a polymer sheet (14), for example a polyethylene sheet. This sheet is then sandwiched between the first thermoplastic adhesive sheet (13) and a second thermoplastic adhesive sheet (15).

The adhesive layers (13, 15) thus prepared are joined to the two individual substrates (11) and (17) and the air is removed from the laminated unit in a known manner by a vacuum treatment. The laminated unit is then finally assembled under pressure in an autoclave.

Given below is an example of how the method according to the invention is adapted so that laminated glazing having a thin-film multilayer comprising at least one metal functional layer having reflection properties in the infrared and/or in solar radiation can include a heating means.

The aim is firstly to seek to optimize the various thicknesses of the multilayer so as to obtain optical characteristics, namely T_{L} and R_{E}, superior to those that are in general needed to achieve the commercial level, while still maintaining similar characteristics, that is to say a T_{L} of greater than 77% and an R_{E} of greater than 28%, and a* and b* colors in reflection maintained within a framework shown in FIG. 3 (blue-green tints).

In all the following examples, the layers are deposited by magnetron cathode sputtering on a clear soda-lime silicate glass 2.1 mm in thickness of the Planilux type (a glass sold by Saint-Gobain Glass).

The silicon-nitride-based layers are deposited from Al-doped or B-doped Si targets in a nitriding atmosphere. The Ag-based layers are deposited from Ag targets in an inert atmosphere and the Ti-based layers from a Ti target, also in an inert atmosphere. The ZnO layers are deposited from targets made of Zn containing 1 to 4% Al by weight. Those layers lying beneath the Ag layers have a standard oxygen stoichiometry while those deposited directly on the silver layers are oxygen-substoichiometric, but still remain transparent in the visible, the stoichiometry being monitored by PEM.

### Base Example

This example relates to the following multilayer: Glass/Si₃N₄: Al/ZnO:Al/Ti/Ag/ZnO₁₋ₓAl/Si₃N₄:Al/ZnO:Al/Ti/Ag/ZnO₁₋ₓ:Al/Si₃N₄:Al.

Si₃N₄:Al means that the nitride contains aluminum. The same applies to ZnO:Al. Furthermore, ZnO₁₋ₓ:Al means that the oxide is deposited with slight oxygen-substoichiometry, without being absorbent in the visible.

This multilayer was used according to the first embodiment of the invention, illustrated in FIG. 1. It was deposited on an inner substrate (17) made of clear soda-lime silicate glass 2.1 mm in thickness of the Planilux type and was then joined to a PVB interlayer sheet (13) 0.76 mm in thickness and then to an outer substrate (18) also made of clear soda-lime silicate glass 2.1 mm in thickness of the Planilux type.

Table 1 below repeats the multilayer stack, with the thicknesses indicated in nanometers for the base example.

TABLE 1

| Glass | Base Example | | Name |
|---|---|---|---|
| Si₃N₄: Al | 27 | nm | Si1 |
| ZnO: Al | 10 | nm | |
| Ti | 0.4 | nm | |
| Ag | 7.6 | nm | ASg1 |
| ZnO₁₋ₓ: Al | 10 | nm | |
| Si₃N₄: Al | 74 | nm | Si2 |
| ZnO: Al | 10 | nm | |
| Ti | 0.4 | nm | |
| Ag | 11.4 | nm | Ag2 |
| ZnO₁₋ₓ: Al | 10 | nm | |
| Si₃N₄: Al | 30 | nm | Si3 |

### Optimized of the Base Example

The modification of the respective thicknesses T of the three silicon-nitride-based layers Si1, Si2 and Si3 and of the two silver layers Ag1 and Ag2 was tested for each layer.

The values obtained at this first step have been plotted in FIGS. 3 to 5 so as to make them easier to interpret.

FIG. 3 illustrates the consequences of the modification in the respective thicknesses of the three silicon-nit ride-based layers Si1, Si2 and Si3 and of the two silver layers Ag1 and Ag2.

The central point indicates the values obtained for the above base example and the arrows indicate the direction of the thickness increase.

It may be seen in this figure that a certain operating margin is possible as regards the thicknesses of the layers Si1, Si2, Si3 and Ag2, while still remaining within the desired colors in reflection, but that, in contrast, a modification in the thickness of Ag1 runs the risk of rapidly departing from the framework of desired colors.

FIG. 4 illustrates the consequences of the thickness variation (ΔT) for the two silver layers—Ag1 as the light curves and Ag2 as the bold curves—on the light transmission T_{L} as the solid curves and on the energy reflection R_{E} as the dotted curves.

It may be seen in this figure that an increase in T_{L} can be obtained by decreasing (negative ΔT) the thickness of Ag2 and by increasing the thickness of Ag1 (positive ΔT), and that an increase in R_{E} may be obtained by increasing the thickness of Ag1.

FIG. 5 illustrates the consequences of the thickness variation (ΔT) for the two silver layers—Ag1 as the light curves and Ag2 as the bold curves—on a* as the solid curves and on b* as the dotted curves.

It may be seen in this figure that the variations in thickness of Ag2 have only a slight influence on the a* and b* values, which both remain almost always negative, and that an increase in Ag1 keeps both the a* and b* values negative, but a decrease in Ag1 makes the a* value and most particularly the b* value unacceptable, as they become positive.

Upon examining these three figures, it is clear that a decrease in the thickness of Ag2 and an increase in the thickness of Ag1 may allow the light transmission and energy reflection characteristics to be improved without causing a significant change in colorimetric response.

An optimization operation was then carried out with specific thickness values for Si1, Si2, Si3 and Ag2. The results obtained are illustrated in Table 2 below.

TABLE 2

| | T | ΔT | T_{L} | | a* | b* | R |
|---|---|---|---|---|---|---|---|
| | (nm) | (nm) | (%) | R_{E} (%) | (D₆₅)/10°) | (D₆₅/10°) | (ohms/□) |
| Si1 | 23.0 | −4.0 | 76.2 | 30.5 | −4.3 | −5.1 | 3.5 |
| | 25.0 | −2.0 | 76.4 | 30.4 | −4.8 | −4.8 | 3.5 |
| | 27.0 | 0.0 | 76.4 | 30.1 | −2.3 | −4.3 | 3.5 |
| | 29.0 | 2.0 | 77.1 | 29.9 | −1.8 | −3.7 | 3.5 |
| | 31.0 | 4.0 | 76.5 | 30.2 | −0.5 | −3.9 | 3.6 |
| Si2 | 70.0 | −4.0 | 76.6 | 30.5 | −2.4 | −6.6 | 3.5 |
| | 72.0 | −2.0 | 76.0 | 30.2 | −1.6 | −3.7 | 3.6 |
| | 74.0 | 0.0 | 76.7 | 30.3 | −2.3 | −4.2 | 3.4 |
| | 76.0 | 2.0 | 75.8 | 30.1 | −3.2 | −4.3 | 3.5 |
| | 78.0 | 4.0 | 75.9 | 29.9 | −4.2 | −4.4 | 3.4 |
| Si3 | 24.0 | −6.0 | 75.2 | 30.6 | −3.4 | −2.5 | 3.5 |
| | 27.0 | −3.0 | 76.1 | 30.0 | −2.7 | −3.4 | 3.6 |
| | 30.0 | 0.0 | 76.9 | 30.7 | −2.5 | −4.6 | 3.5 |
| | 33.0 | 3.0 | 77.1 | 30.1 | −1.7 | −5.9 | 3.6 |
| | 36.0 | 6.0 | 77.6 | 29.9 | −0.9 | −7.5 | 3.5 |
| Ag2 | 9.6 | 0.0 | 78.3 | 26.6 | −3.7 | −4.6 | 4.1 |
| | 9.8 | 0.2 | 77.2 | 27.3 | −3.5 | −4.7 | 4.2 |
| | 10.0 | 0.4 | 77.9 | 27.7 | −3.5 | −4.6 | 4.2 |
| | 10.2 | 0.6 | 78.1 | 27.8 | −3.4 | −4.4 | 3.9 |
| | 10.6 | 1.0 | 77.5 | 28.4 | −2.7 | −4.5 | 3.8 |
| | 11.0 | 1.4 | 77.1 | 29.7 | −2.8 | −4.6 | 3.7 |
| | 11.4 | 1.8 | 76.2 | 29.4 | −2.7 | −4.3 | 3.7 |

These measurements indeed confirm the possibility of decreasing the thickness of Ag2 and of increasing the thickness of Ag1 for improving the light transmission and energy reflection properties without causing a substantial change in colorimetric response.

More particularly, a decrease in the thickness of Ag2 of between 0.4 nm and 1.2 nm, that is to say between 4% and 11% of the conditions of the base example, leads to the desired values. This decrease may be lead in parallel to an increase in the thickness of Ag1 of 0.5 nm, i.e. 7% of the thickness of the base example.

These measurements also reveal the possibility of varying the thicknesses of Si1, Si2 and Si3 in order to obtain a similar effect—the color remains blue, but it lies outside the intended color palette.

It has also been found that the modifications in thickness of the silver layers do not greatly modify the mechanical properties of the multilayer.

In the foregoing, the present invention has been described in the case of one example. Of course, a person skilled in the art is capable of producing various alternative forms of the invention without thereby departing from the scope of the patent as defined by the claims.

1. Laminated glazing (10, 10′) for vehicles, comprising at least one interlayer sheet (13, 16) of thermoplastic polymer positioned between two substrates (11, 17), each substrate thus having a respective face (2, 3) turned toward said interlayer sheet (13, 16), said glazing having reflection properties in the infrared and/or in solar radiation, characterized in that a heating means (12) having a power density of at least 400 W/m2, or even at least 500 W/m², is associated with the face (2), in that a means (15) having reflection properties in the infrared and/or in solar radiation is associated with the face (3) and in that said glazing has a light transmission of at least 70%, or even at least 75%.

2. The glazing (10, 10′) as claimed in claim 1, characterized in that said heating means (12) is positioned against that face of the interlayer sheet (13) which is turned toward the outside.

3. The glazing (10, 10′) as claimed in claim 1, characterized in that said means (15) having reflection properties in the infrared and/or in solar radiation is positioned on the internal face of the inner substrate (17) or is positioned on that face of a central thermoplastic polymer sheet (14) which is turned toward the inside, said central thermoplastic polymer sheet (14) being positioned between two interlayer thermoplastic polymer sheets (11, 16).

4. The glazing (10, 10′) as claimed in claim 1, characterized in that said means (15) consists of a thin-film multilayer comprising an alternation of n functional layers A having reflection properties in the infrared and/or in solar radiation, and (n+1) coatings B where n≧1, said coatings B comprising a dielectric layer or a superposition of dielectric layers so that each functional layer is placed between two coatings B.

5. The glazing (10, 10′) as claimed in claim 4, characterized in that the functional layer (A) is in contact with the dielectric coating B placed below and/or above it via a layer C that absorbs at least in the visible, of the metallic, and optionally nitrided, type.

6. The glazing (10, 10′) as claimed in claim 5, characterized in that the thickness of the absorbent layer C does not exceed 1 nm.

7. The glazing (10, 10′) as claimed in claim 5 characterized in that at least one absorbent layer C is based on titanium, nickel, chromium, niobium or zirconium, or on a metal alloy containing at least one of these metals.

8. The glazing (10, 10′) as claimed in claim 4, characterized in that n≧2 and in that the thickness of each functional layer A is approximately the same and is less than 15 nm.

9. The glazing (10, 10′) as claimed in claim 4, characterized in that the functional layer A is based on silver or a silver alloy.

10. The glazing (10, 10′) as claimed in claim 1, characterized in that said heating means (12) consists of an array of conducting wires and an array of twisted wires.

11. The glazing (10, 10′) as claimed in claim 1, characterized in that said heating means (12) consists of at least one layer of conductive material.

12. The glazing (10, 10′) as claimed in claim 1, characterized in that it has an energy reflection of between 20 and 40%.

13. The glazing (10, 10′) as claimed in claim 4, characterized in that the multilayer comprises the following sequence of layers:
ZnO/Ti/Ag/ZnO
with one of the following complete multilayers:
Si₃N₄/ZnO/Ti/Ag/ZnO/Si₃N₄/ZnO/Ti/Ag/ZnO/Si₃N₄
ZnO/Ti/Ag/ZnO/Si₃N₄/ZnO/Ti/Ag/ZnO/Si₃N₄
ZnO/Ti/Ag/ZnO/Ti/Ag/ZnO/Si₃N₄
Si₃N₄/ZnO/Ti/Ag/ZnO/Ti/Ag/ZnO/Si₃N₄
it being possible for the Si₃N₄ and/or ZnO layers to contain an element or a metal, in a minor amount relative to the Si or Zn, of the Al or boron type.

14. The glazing (10, 10′) as claimed in claim 4, characterized in that, after the thin-film multilayer has been deposited on the substrate (17), the latter undergoes a heat treatment at above 500° C. for the purpose of bending it, so as, after bending, to have a color in external reflection in the blues, in the greens or in the blue-greens.

15. Application of the glazing (10, 10′) as claimed in claim 1 as a windshield or the front side windows of a motor vehicle, said glazing having a solar-protection and heating function.

16. A method of producing laminated glazing (10, 10′) for vehicles, comprising at least one interlayer sheet (13, 16) of thermoplastic polymer positioned between two substrates (11, 17), each substrate thus having a respective face (2, 3) turned toward said interlayer sheet (13, 16), said glazing having reflection properties in the infrared and/or in solar radiation, characterized in that a heating means (12) having a power of at least 400 W/m², or even at least 500 W/m², is associated with the face (2), and a means (15) having reflection properties in the infrared and/or in solar radiation being associated with the face (3), said means (15) having reflection properties in the infrared and/or in solar radiation is adapted so that said glazing has a light transmission of at least 70%, or even at least 75%.

17. The method as claimed in claim 16, characterized in that the means having reflection properties in the infrared and/or in solar radiation consisting of a thin-film multilayer comprising two metal functional layers, the thickness of the first functional metal layer starting from the substrate is increased and the thickness of the second metal functional layer is decreased, preferably without modifying the thicknesses of the other layers.

18. The method as claimed in claim 17, characterized in that the increase in the thickness of the first metal functional layer is less, in absolute value, than the decrease in the thickness of the second metal functional layer.

19. The method as claimed in claim 16, characterized in that, the means having reflection properties in the infrared and/or in solar radiation consisting of a thin-film multilayer comprising two metal, the thickness of at least one absorbent layer C placed just beneath a metal functional layer is decreased.
